(19) United States
(12) Patent Application Publication
(10) Pub. No.: US 2026/0259050 A1
(43) Pub. Date: Sep. 3, 2026

(54) METHOD TO AUTOMATICALLY POSITION BLANKS IN A STRIP AND TO CALCULATE THE ASSOCIATED SCRAP RATIO

(71) Applicant: ArcelorMittal, Luxembourg (LU)

(72) Inventor: Alexandre BLAISE, Montataire (FR)

(21) Appl. No.: 18/871,498

(22) PCT Filed: Jun. 17, 2022
(86) PCT No.: PCT/IB2022/055634

§ 371 Date: Dec. 4, 2024

(51) Int. Cl. G01B 21/20

(52) U.S. Cl. CPC G01B 21/20

(57) ABSTRACT

A method for the computerized positioning of two blanks to be cut out in a longitudinally extending strip including the steps of determining the inner dimensions of each blank in the longitudinal direction, determining the distances in the longitudinal direction between the left side of blank A and the right side of blank B and conversely when the blanks are superimposed, and deducting the pitches between two neighbouring blanks A and B and two neighbouring blanks B and A. A method for the computerized scrap ratio calculation using the blank positioning method and a method for the computerized calculation of the material cost of the blanking operation using the scrap ratio calculation.

The present invention relates to the manufacture of blanks and in particular to the manufacture of blanks cut out from a rectangular flat strip of material generally extending in a longitudinal direction.

### BACKGROUND

In many material manufacturing processes of generally flat materials, the continuous nature of the manufacturing process implies that the final manufactured product is in the form of a long strip generally extending in a longitudinal direction. This is the case for example in flat sheet metal production, such as flat steel products or flat aluminum products. It is also the case in the pulp and paper industry or when manufacturing fabrics and textiles. The aforementioned strip is often conditioned by winding it in a coil shape in order to store it and transport it efficiently.

One common way of using the material in the subsequent transformation processes is to cut out shapes having pre-determined contours from said strip. For example, one can cut out metal blanks in the case of a metallic strip or cut-outs of fabrics or textile in the fashion industry. In the case of a metallic strip, this operation is called blanking and the ensuing product is called a metal blank, i.e. a generally flat piece of metal having a pre-determined contour suitable for use in subsequent transformation processes. This operation can be performed for example by punching, jet water cutting, oxy cutting or laser cutting.

The term blank will be used hereafter for simplicity sake, but, as will be easily understood, the application field of the current invention is not limited to metallic materials.

### SUMMARY OF THE INVENTION

The material left in the strip after cutting out the blanks is designated as scrap. Scrap is a waste material of the blanking process and should be kept to a minimum in order to optimize the productivity, to minimize the environmental impact and to minimize the cost of the blanking operation. In the case of the environmental impact, the production process to manufacture the raw material strip itself has an environmental foot print, such as for example the emission of CO₂. By minimizing the scrap and therefore maximizing the overall output of the industrial process, the environmental impact can be kept as low as possible.

In the current invention, the term cost refers generically to for example an environmental cost, a productivity cost or a financial cost.

In the current invention, the configuration is the following: a strip in which two blanks are cut out, each blank having a predetermined contour and each having a fixed orientation towards the longitudinal direction and a given offset from one another in the transverse direction. The positioning of the two blanks relative to one another in the longitudinal direction will determine a pattern which is then repeated as long as the strip extends in the longitudinal direction. The fact that the orientation of the blanks is fixed can be an industrial constraint for example due to anisotropic properties in the case of metallic materials, for example inherited from the rolling process in the case of steel or aluminum; it can also be linked to other considerations such as pattern in the fabric industry for example.

The current invention aims at providing an automated method to position said given blanks in a strip in an optimal material usage configuration and to calculate the ensuing scrap ratio. Said scrap ratio being defined as the ratio between the scrap generated by the blanking process to the total amount of strip material used.

The current invention further aims at providing an automated method to calculate the blank cost associated to the material use in the blanking operation.

By providing optimized computer implemented methods to position the blanks, calculate the scrap ratio and the material cost, the current invention allows to efficiently design and evaluate the cost of a blanking process. Furthermore, the automation of said operations allows to use them in subsequent optimization routines. For example, it can be used in a subsequent routine to find out the best combination in terms of blank orientations and transversal offset to minimize the overall scrap.

The present invention provides a computer implemented method for the positioning of a blank A and a blank B in a flat strip (1) having a rectangular shape and extending generally in a longitudinal direction L and over a limited width in a transverse direction T, the lowest point of blank B being offset in the transverse direction by an offset dy compared to the lowest point of blank A, said method consisting of the following steps:
providing an X, Y coordinate system parallel to L, T, where blank A is positioned in the X, Y coordinate system so that the furthest left point of blank A is located at X=0 and so that the lowest point of blank A is located at Y=0 and blank B is positioned so that the furthest left point of blank B is located at X=0 and the lowest point of blank B is located at Y=dy,
providing a numerical representation of the contours of blank A and blank B in said X, Y coordinate system consisting of discrete sets of vertices {A₁, . . . , A_{P}} and {B₁, . . . , B_{q}}, p and q being integers greater than or equal to 3, said vertices being joined by straight edges,
computing for each vertex Aᵢ the distance dAᵢA being defined as the difference between the largest X value taken by the contour of blank A and the smallest X value taken by the contour of blank A at the Y value of vertex Aᵢ and calculating the largest inner transverse distance dAA defined as the maximum value of all dAᵢA,
computing for each vertex Bᵢ the distance dBᵢB being defined as the difference between the largest X value taken by the contour of blank B and the smallest X value taken by the contour of blank B at the Y value of vertex Bᵢ and calculating the largest inner transverse distance dBB defined as the maximum value of all dBᵢB,
computing for each vertex Aᵢ located at a Y value for which at least one point of the contour of blank B is present the oriented distances dAᵢB and dBAᵢ defined respectively as the difference between the largest X value taken by the contour of blank B and the smallest X value taken by the contour of blank A at the Y value of vertex Aᵢ and as the difference between the largest X value taken by the contour of blank A and the smallest X value taken by the contour of blank B at the Y value of vertex Aᵢ,
computing for each vertex Bᵢ located at a Y value for which at least one point of the contour of blank A is present the oriented distances dABᵢ and dBᵢA defined respectively as the difference between the largest X value taken by the contour of blank B and the smallest X value taken by the contour of blank A at the Y value of vertex Bᵢ and as the difference between the largest X value taken by the contour of blank A and the smallest X value taken by the contour of blank B at the Y value of vertex Bᵢ,
computing the oriented distance dAB defined as the maximum value of all dAᵢB and dAB_{I} values, and computing the oriented distance dBA defined as the maximum value of all dBᵢA and dBA_{I} values,
Δ₁ being defined as the pitch in the longitudinal direction between the left extremity of an A blank and the left extremity of its right-hand neighboring B blank, Setting Δ₁ to the value dBA,
Δ₂ being defined as the pitch between the left extremity of a B blank and the left extremity of its right-hand neighboring A blank, setting Δ₂ to dBA if dAB+dBA≥dAA and dAB+dBA≥dBB, setting Δ₂ to dAA−dBA if dAB+dBA<dAA and dAA≥dBB, setting Δ₂ to dBB−dBA if dAB+dBA<dBB and dBB>dAA, and
positioning a first blank A in the strip, positioning a first blank B with a transverse offset of dy and a longitudinal offset of Δ₁ compared to said first blank A, positioning the following blank A in transversal alignment with said first blank A and with a longitudinal offset of Δ₂ towards said first blank B and repeating the pattern along strip 1 as far as it extends longitudinally.

### BRIEF DESCRIPTION THE DRAWINGS

The present invention will now be described in detail and illustrated by examples without introducing limitations, with reference to the appended figures:

FIG. 1 is an overview of the configuration of the positioning of two blanks in a strip, the longitudinal direction is indicated by the arrow marked “L”, while the transverse direction is indicated by the arrow marked “T”,

FIGS. 2A and 2B are illustrations of the computation method respectively of dAA and dBB,

FIGS. 3A and 3B are illustrations of the computation method respectively of dAB and dBA,

FIG. 4 is a further example on a more complex shape of determination of dAᵢA type values,

FIG. 5A is an example of dAA, dBB, dAB and dBA determination on more complex shapes and FIG. 5B is the illustration of the positioning of blanks A and B of FIG. 5A in a strip,

FIGS. 6A, 6B, and 7A, 7B follow the same principle as FIGS. 5A and 5B on blanks having the same shape but with different orientations,

FIGS. 8 and 9 represent particular embodiments of the present invention in which the blanking tolerance and the width tolerance of the strip are taken into consideration to calculate the scrap ratio and the blank cost.

### DETAILED DESCRIPTION

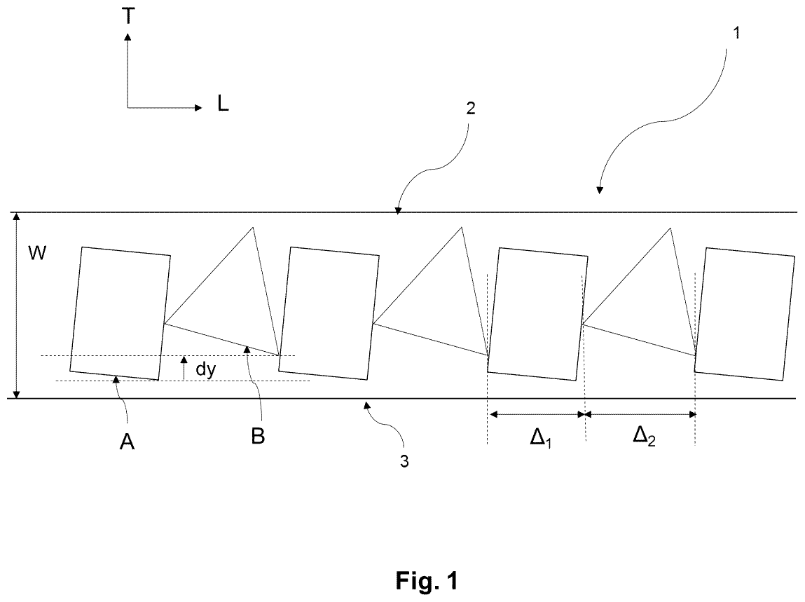

In the present invention, referring to FIG. 1, the longitudinal direction refers to the main direction in which a strip 1 extends and the transverse direction refers to the perpendicular direction of said longitudinal direction in the plane. The strip 1 further extends over a limited width between two parallel edges 2 and 3 in the transverse direction Y and extends over a width W in said direction.

The strip 1 has a top and a bottom side, also referred to as a top and bottom face. All appended figures are 2-dimensional top views on which only the top side is visible. The distance between the top and bottom faces is designated as the thickness of the strip. The thickness can be measured for example using a micrometer, the spindle and anvil of which are placed on the top and bottom faces.

In the following description and claims, the terms longitudinal and horizontal have the same meaning, the terms transverse and vertical have the same meaning. The terms “left” and “right” will be used in the subsequent description and claims, they respectively refer to a relative positioning further back and further along the longitudinal direction, i.e. along the direction marked by the “L” arrow in FIG. 1. The terms “up” (and “above”, “higher”, etc.), “down” (and “below”, “lower”, etc.) will be used in the subsequent description and claims, they respectively refer to a relative positioning further back and further along the transverse direction, i.e. along the direction marked by the “T” arrow in FIG. 1.

Referring to FIG. 1, a first blank A having a first contour and a second blank B having a second contour are cut out from the strip 1.

Blank B is offset in the transverse direction from blank A by a transverse offset dy, which is defined as the difference in transversal elevation between the lowest point in the transverse direction of blank contour B and blank contour A.

A first object of the present invention is to determine in an automated way how to position blanks A and B in strip 1, in order to use the smallest possible amount of material. This is the case when a first set of blank A and blank B touch the following set of blanks A and B in at least one point without overlap. The ensuing pattern is then repeated along the longitudinal direction. There are potentially several different ways of positioning blanks A and B in order to optimize material use. Each of these configurations is equivalent in terms of material use. The current invention aims at identifying one such possible configuration only.

The missing element to position blanks A and B is the pitch Δ₁ in the longitudinal direction between the left extremity of an A blank and the left extremity of its right-hand neighboring B blank as well as the pitch Δ₂ between the left extremity of a B blank and the left extremity of its right-hand neighboring A blank. Once said pitches have been determined it is possible to position the blanks in the strip and it is then possible to also compute the scrap ratio and the blanking material cost, as will be described further.

The pitches Δ₁ and Δ₂ take into account the shape and inner dimensions of A and B along the longitudinal direction as well as the interaction between blanks A and B in the longitudinal direction.

In order to optimize the computation time, the inventors have developed a method which involves only the inner distances in the longitudinal direction between the vertices and edges of each singular blank A and B and which involves only the interaction in the longitudinal direction between blanks A and B in points of the width at which a vertex of either blank A or B is located.

Because the number of vertices of each blank is discreet and generally quite limited, the method of the current invention allows to compute the scrap ratio very rapidly.

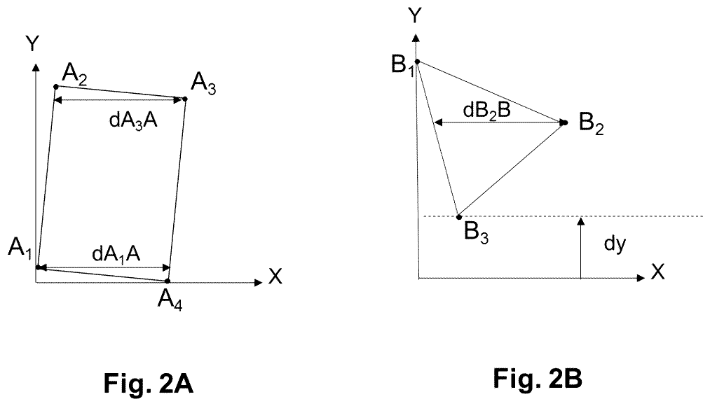

Referring to FIGS. 2A and 2B, an X, Y coordinate system is used to locate the vertices and contours of blanks A and B. The X axis is parallel to the strip longitudinal direction while the Y axis is parallel to the strip transverse direction. As a matter of convention, blank A is positioned in the coordinate system so that the point furthest left of blank A is located at X=0 and the lowest point of blank A is located at Y=0. Blank B is positioned so that the point furthest left of blank B is located at X=0 and the lowest point of blank B is located at Y=dy.

The blank contours of A and B are represented respectively by vertices A₁, A₂, A₃, A₄ and B₁, B₂, B₃ joined by straight edges. Each vertex Aᵢ is identified by its coordinates (XAᵢ, YAᵢ) and each vertex Bᵢ is identified by its coordinates (XBᵢ, YBᵢ).

For clarity sake, blanks A and B of the figures have simple shapes with long straight edges. However, the method applies to any 2-dimensional contour. In the case of contours comprising curved edges, they can be approximated by a succession of smaller straight segments, thus defining a set of vertices and connecting edges.

In the general case, blank A is thus represented by the set of its p vertices {A₁, . . . , A_{P}} and blank B is represented by the set of its q vertices {B₁, . . . , B_{q}}, where p and q are integers equal to or greater than 3.

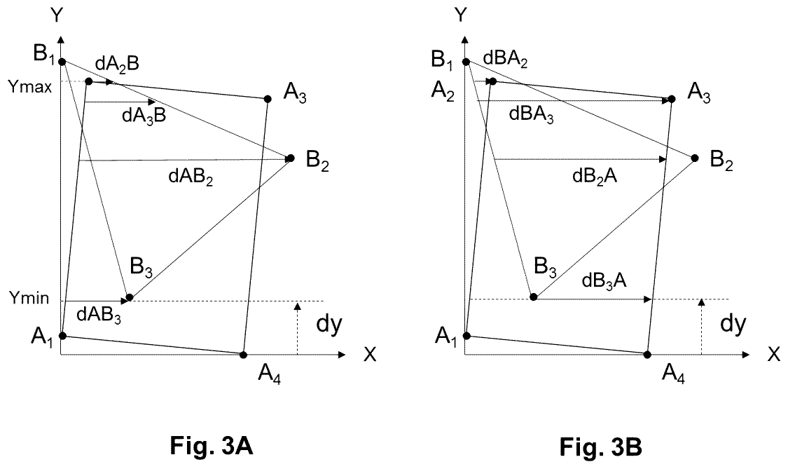

To determine Δ₁ and Δ₂, it is necessary to first compute the maximum dimensions in the longitudinal direction dAA and dBB respectively of blanks A and B, as well as the maximum longitudinal offsets dAB and dBA respectively from blank A to blank B and from blank B to blank A, when said blanks are superimposed (see FIGS. 3A and 3B).

This is done by implementing the following steps:
Computing for each vertex Aᵢ the distance dAᵢA being defined as the difference between the largest X value taken by the contour of blank A and the smallest X value taken by the contour of blank A at the Y value of vertex Aᵢ and calculating the largest inner transverse distance dAA defined as the maximum value of all dAᵢA.
Computing for each vertex Bᵢ the distance dBᵢB being defined as the difference between the largest X value taken by the contour of blank B and the smallest X value taken by the contour of blank B at the Y value of vertex Bᵢ and calculating the largest inner transverse distance dBB defined as the maximum value of all dBᵢB.

In the simple case of FIG. 2A for example, dA₂A and dA₄A are equal to 0, while dA₃A and dA₁A have equal values, thus dAA=dA₃A=dA₁A.

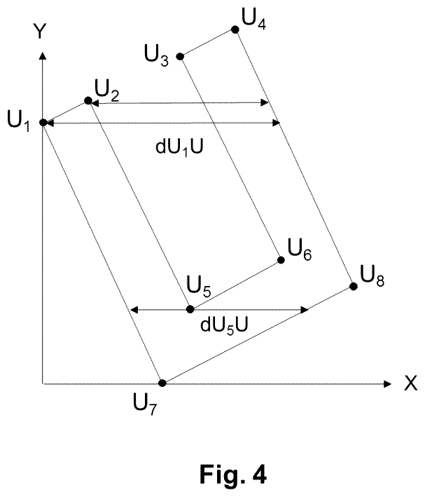

Blanks A and B of FIGS. 2A, 2B are simple shapes for clarity sake but in the case of more complex shapes such as blank U depicted on FIG. 4 for example, there can be instances in which a straight line parallel to the X axis will cross the contour several times such as in the case of U₁ and U₂. In this case, the segments corresponding to dU₁U and dU₂U, as depicted on FIG. 4, can cross the blank contour to extend from the further left point to the furthest right point of the contour. To illustrate another possible configuration, in the case of dU₅U the segment does not have vertex Us as one of its extremities because Us is in between the furthest left and furthest right point of the contour at its Y value.

The longitudinal offsets dAB and dBA are then calculated by applying the following method:
Computing for each vertex Aᵢ located at a Y value for which at least one point of the contour of blank B is present the oriented distances dAᵢB and dBAᵢ defined respectively as the difference between the largest X value taken by the contour of blank B and the smallest X value taken by the contour of blank A at the Y value of vertex Aᵢ and as the difference between the largest X value taken by the contour of blank A and the smallest X value taken by the contour of blank B at the Y value of vertex Aᵢ.
Computing for each vertex Bᵢ located at a Y value for which at least one point of the contour of blank A is present the oriented distances dABᵢ and dBᵢA defined respectively as the difference between the largest X value taken by the contour of blank B and the smallest X value taken by the contour of blank A at the Y value of vertex Bᵢ and as the difference between the largest X value taken by the contour of blank A and the smallest X value taken by the contour of blank B at the Y value of vertex Bᵢ.
Computing the oriented distance dAB defined as the maximum value of all dAᵢB and dAB_{I} values, and computing the oriented distance dBA defined as the maximum value of all dBᵢA and dBA_{I} values.

In the case of FIG. 3A for example, which represents the oriented vectors corresponding to the values dAᵢB and dABᵢ, dAB will be equal to dAB₂.

In the case of FIG. 3B, which represents the oriented vectors corresponding to the values dBᵢA and dBAᵢ, dBA will be equal to dBA₃.

Having computed dAA, dBB, dAB and dBA, the following method allows to compute Δ₁ and Δ₂:

$${Δ}_{1} = dBA ,$$

$${Δ}_{2} = dBA if dAB + dBA \geq dAA and dAB + dBA \geq dBB ,$$

$${Δ}_{2} = dAA - dBA if dAB + dBA < dAA and dAA \geq dBB ,$$

$${Δ}_{2} = dBB - dBA if dAB + dBA < dBB and dBB > dAA .$$

Knowing Δ₁ and Δ₂, blanks A and B can now be positioned in strip 1 by positioning a first blank A in the strip, positioning a first blank B with a vertical offset of dy and a longitudinal offset of Δ₁ compared to said first blank A, positioning the following blank A in transversal alignment with said first blank A and with a longitudinal offset of Δ₂ towards said first blank B and repeating the pattern along strip 1 as far as it extends longitudinally.

The inventors have found that this method allows to efficiently automatize the optimal disposition of blanks A and B.

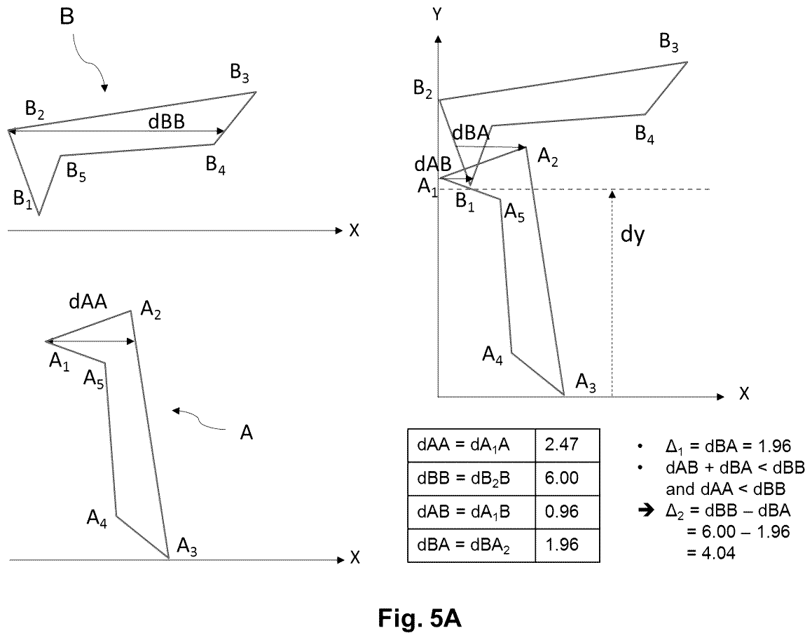

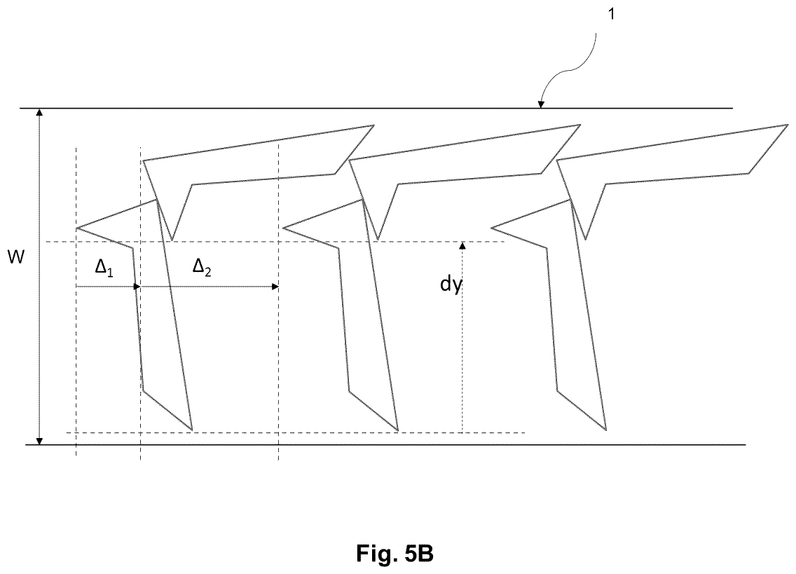

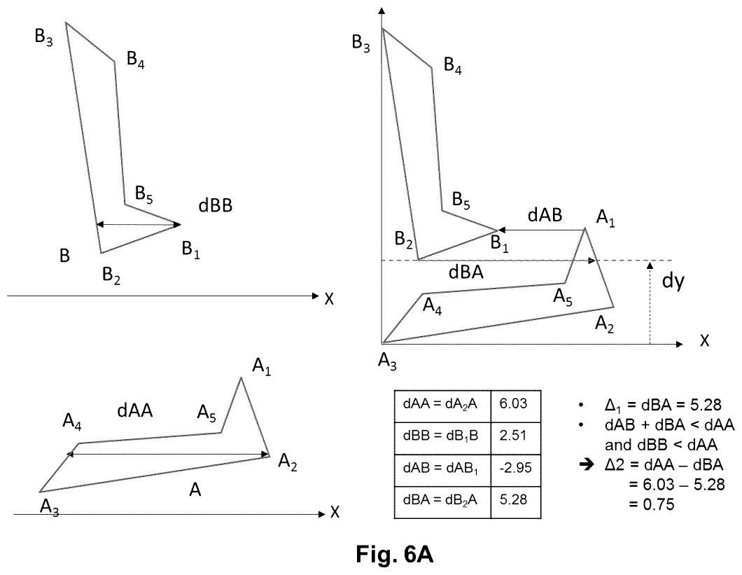

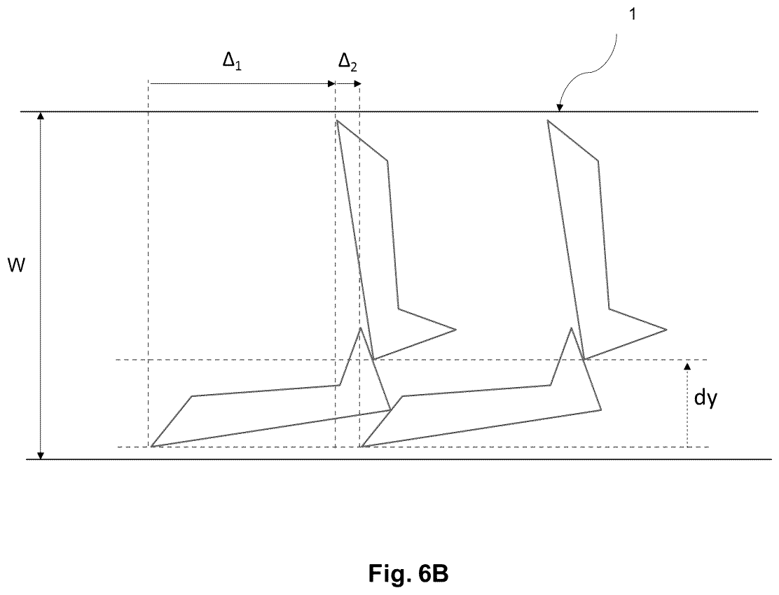

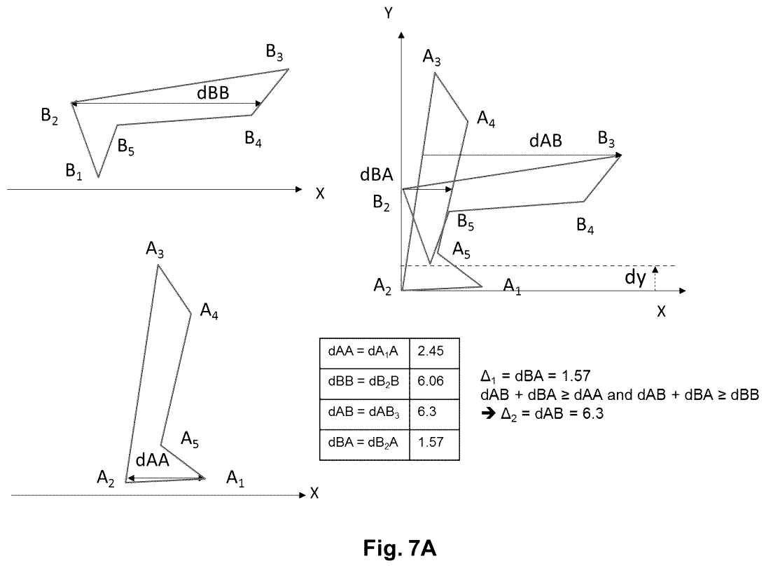

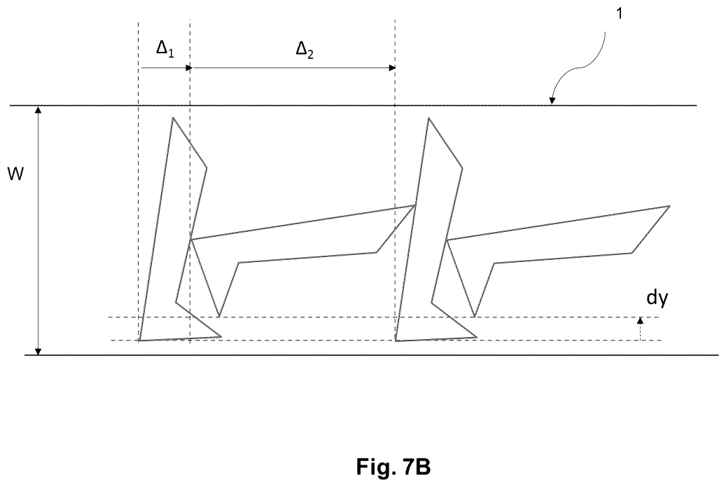

FIGS. 5A, 6A, and 7A are examples of dAA, dBB, dAB and dBA determination on more complex shapes. On each figure, the top left hand-side shows how dBB is determined (only the maximum dBᵢB is depicted for clarity sake), the bottom left hand-side shows how dAA is determined, the top right hand side show how dAB and dBA are determined and the table in the bottom right hand side summarizes the values for dAA, dBB, dAB and dBA and to which individual dAᵢA, dBᵢB, dAᵢB/dABᵢ, dBᵢA/dBAᵢ they correspond. For example, in the configuration of FIG. 6A, dAB is negative, because all individual dAᵢB/dABᵢ are negative (there are no points of contour A at the left of contour B in the Y value range of interaction between superimposed blanks A and B). In this case, dAB is actually the dAᵢB/dABᵢ having the smallest absolute value of all individual dAᵢB/dABᵢ, which will correspond to the maximum dAᵢB/dABᵢ value. The bottom right hand side table summarizes all dAA, dBB, dAB and dBA values and details the calculation step to determine pitches Δ₁ and Δ₂.

FIGS. 6C, 7C and 8C depict the implementation of the computerized positioning method using previously computed pitches Δ₁ and Δ₂.

Knowing Δ₁ and Δ₂, it is possible to compute automatically the scrap ratio % Scrap using the following formula:

$$\% Scrap = 1 - \frac{Area\_A + Area\_B}{W * ( {Δ}_{1} + {Δ}_{2} )}$$

In order to calculate the blank cost Cost_blank of A and B, which is defined as the material cost of blanks A and B taking into account the cost of the material, the scrap ratio and the cost of scrap if a scrap buy-back market is available, the following further information is necessary:
a strip thickness t, defined above as the distance between the top side and the bottom side of the strip, t is for example expressed in mm,
a material cost Cost_material for one unit of mass, for example expressed in currency/ton,
in the case in which the scrap material can be bought back, for example this is the case in the steel industry where the scrap is re-melted, a Scrap cost Cost_Scrap per unit of mass, for example expressed in currency/ton,
a material density ρ, defined as the ratio between the mass and the volume of the material, ρ is usually expressed in kg/m³.

Cost_blank can be computed automatically using the following formula:

$$M\_Section = ρ * t * W * ( {Δ}_{1} + {Δ}_{2} )$$

$$Cost\_blank = Cost\_material * M\_Section - Cost\_scrap * \% Scrap * M\_Section$$

In a particular embodiment, the material cost Cost_material depends on the width of the strip W and is in fact provided in the form of a database Cost_database, comprising a set of n elements (Width_rangeᵢ, Cost_materialᵢ), n being an integer equal to or higher than 2 and i being comprised between 1 and n, wherein Width_rangeᵢ is a width range having a minimum and maximum strip width value and Cost_materialᵢ is the material cost for one unit of mass when the width of the strip W is comprised within Width_rangeᵢ.

Variable costs according to the strip width can occur when the industrial cost of producing a strip is indeed dependent on the width. For example, the industrial cost can increase with the width if said width increase is associated with a lower productivity. For example, the material cost can increase with the width if large width material can only be produced in a determined industrial facility, entailing higher logistic costs.

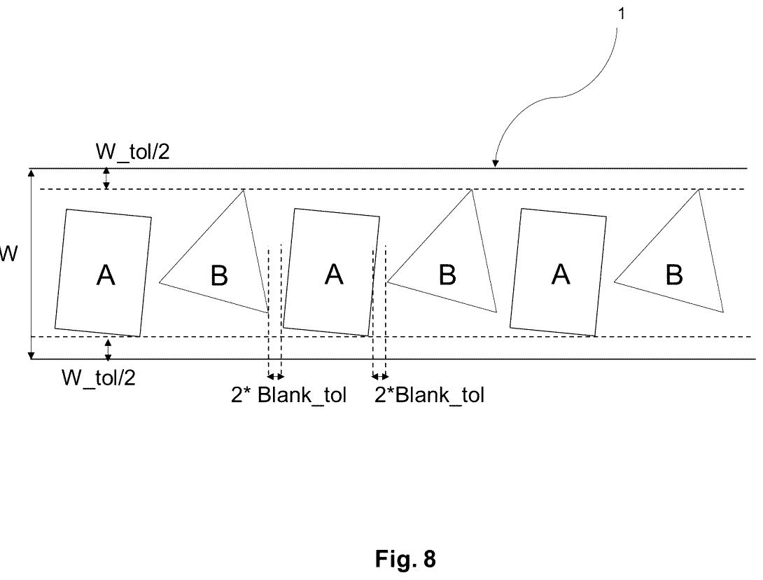

In a particular embodiment, the width of the coil W takes into account a width tolerance W_tol, usually expressed in mm. This then affects the width value W used in calculating the scrap cost and the blanking cost. Said width tolerance corresponds for example to the precision that the strip production line can achieve in terms of width. In order to guarantee that blanks A and B will fit into the strip even when the width of the manufactured strip is at the lower end of the width tolerance spectrum, it will be necessary to aim for a strip width W corresponding at least to the minimum width necessary to fit in blank A and blank B within said strip to which the width tolerance W_tol is added. This configuration is illustrated on FIG. 8, where a margin of W_tol/2 is left on either side of the strip 1.

In a particular embodiment, a blanking tolerance Blank_tol, usually expressed in mm, is taken into account when positioning blanks A and B in the strip and thus also when calculating the scrap ratio and the blank cost. Said blanking tolerance corresponds to the precision of the tool used to cut out the blanks in the strip. In order to guarantee that there is no overlap between the blanks when cutting them out of the strip, the distance between two neighboring blanks should not be below 2*Blank_tol (indeed each blank is cut out with a precision of Blank_tol and only by providing for a distance between two neighboring blanks taking into account the blanking tolerance of each individual blank can the risk of overlap be fully avoided). This is also illustrated in FIG. 8.

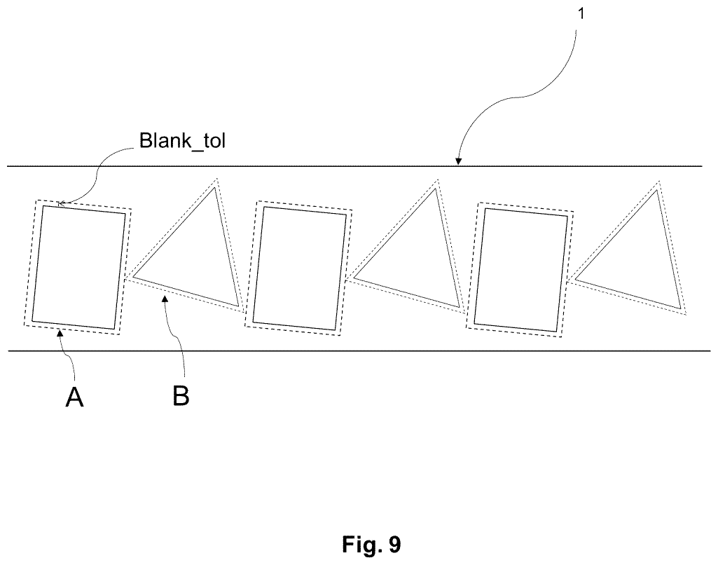

In a particular embodiment, such as illustrated on FIG. 9, the blanking tolerance is taken into account in the above described Δ₁ and Δ₂ calculation method and associated blank positioning, scrap ratio and blank cost determination methods by first geometrically inflating blanks A and B by a factor of Blank_tol before applying the blank positioning method. It should be noted that, while the inflated blank contours of A and B are taken into account for the calculation of Δ₁ and Δ₂, when calculating the scrap ratio % Scrap, Area_A and Area_B of the formula are the areas of the non inflated blank contours. Indeed, the material usage in the strip remains a direct function of the areas Area_A and Area_B and not of the inflated blank contour areas.

In a particular embodiment, such as depicted on FIGS. 5A-B, 6A-B and 7A-B, the above described methods are applied to a configuration wherein blank B has exactly the same contour as blank A after rotating blank B around an axis perpendicular to the top face of the strip. This is a very common case in which there is in fact only one blank shape to be cut out from a strip 1.

In a particular embodiment, the above described methods are applied to a configuration wherein blank B is a mirror image contour of blank A after rotating blank B around an axis perpendicular to the top face of the strip. This is a very common case for example in the automotive industry in which many parts are present on both sides of the vehicle as a right hand and left hand part, which are generally mirror images of one another.

What is claimed is:

1-9. (canceled)

10. A computer implemented method for positioning of a blank A and a blank B in a flat strip having a rectangular shape and extending generally in a longitudinal direction L and over a limited width in a transverse direction T, the lowest point of blank B being offset in the transverse direction by an offset dy compared to the lowest point of blank A, the method comprising of the following steps:
providing a X, Y coordinate system parallel to L, T, where blank A is positioned in the X, Y coordinate system, wherein a furthest left point of blank A is located at X=0, wherein a lowest point of blank A is located at Y=0 and blank B is positioned, wherein a furthest left point of blank B is located at X=0 and a lowest point of blank B is located at Y=dy;
providing a numerical representation of a contour of blank A and blank B in the X, Y coordinate system comprising discrete sets of vertices {A₁, . . . , A_{P}} and {B₁, . . . , B_{q}}, p and q being integers greater than or equal to 3, the vertices being joined by straight edges;
computing for each vertex Aᵢ a distance dAᵢA being defined as a difference between a largest X value taken by the contour of blank A and a smallest X value taken by the contour of blank A at the Y value of vertex Aᵢ and calculating a largest inner transverse distance dAA defined as the maximum value of all dAᵢA;
computing for each vertex Bᵢ a distance dBᵢB being defined as a difference between a largest X value taken by the contour of blank B and a smallest X value taken by the contour of blank B at the Y value of vertex Bᵢ and calculating a largest inner transverse distance dBB defined as the maximum value of all dBᵢB;
computing for each vertex Aᵢ located at a Y value wherein at least one point of the contour of blank B is present oriented distances dAᵢB and dBAᵢ defined respectively as a difference between a the X value taken by the contour of blank B and the X value taken by the contour of blank A at the Y value of vertex Aᵢ and as a difference between the smallest X value taken by the contour of blank A and the smallest X value taken by the contour of blank B at the Y value of vertex Aᵢ;
computing for each vertex Bᵢ located at a Y value for which at least one point of the contour of blank A is present oriented distances dABᵢ and dBᵢA defined respectively as a difference between the largest X value taken by the contour of blank B and the smallest X value taken by the contour of blank A at the Y value of vertex Bᵢ and as a difference between the largest X value taken by the contour of blank A and the smallest X value taken by the contour of blank B at the Y value of vertex Bᵢ;
computing an oriented distance dAB defined as a maximum value of all dAᵢB and dAB_{I} values, and computing an oriented distance dBA defined as a maximum value of all dBᵢA and dBA_{I} values;
Δ₁ being defined as a pitch in the longitudinal direction between a left extremity of the A blank and the left extremity of its right-hand neighboring B blank, setting Δ₁ to a value dBA;
Δ₂ being defined as a pitch between the left extremity of the B blank and a left extremity of its right-hand neighboring A blank, setting Δ₂ to dBA if dAB+dBA≥dAA and dAB+dBA≥dBB, setting Δ₂ to dAA−dBA if dAB+dBA<dAA and dAA≥dBB, setting Δ₂ to dBB−dBA if dAB+dBA<dBB and dBB>dAA; and
positioning a first blank A in the strip, positioning a first blank B with a transverse offset of dy and a longitudinal offset of Δ₁ compared to the first blank A, positioning a following blank A in transversal alignment with the first blank A and with a longitudinal offset of Δ₂ towards the first blank B and repeating the pattern along the strip as far as the strip extends longitudinally.

11. The method according to claim 10 further including:
providing a blanking tolerance Blank_tol as an initial step;
then geometrically inflating blanks A and B by the factor of Blank_tol;
then applying the steps of the method of claim 10 to the resulting inflated blank contours of blank A and blank B.

12. The method according to claim 10 wherein blank B has exactly the same contour as blank A after rotating blank B around an axis perpendicular to a top face of the strip.

13. The method according to claim 10 wherein blank B has a mirror image contour of blank A after rotating blank B around an axis perpendicular to the top face of the strip.

14. A method for a computerized calculation of a scrap ratio % Scrap, defined as the ratio between a scrap generated by a blanking process to cut out blank A and B from the strip to a total amount of strip material used, wherein blank A and blank B respectively have surface areas Area_A and Area_B, wherein the strip extends over a width W in the transverse direction and Δ₁ and Δ₂ are calculated according to the method as recited in claim 10, % Scrap being computed according to the following formula:
$$\% Scrap = 1 - \frac{Area\_A + Area\_B}{W * ( {Δ}_{1} + {Δ}_{2} )} .$$

15. A method for a computerized calculation of a blank cost Cost_blank wherein the blank cost Cost_blank is a material cost of blanks A and B taking into account a cost of the material a strip is made of, a scrap ratio and a cost of scrap, wherein t is a strip thickness, defined as a distance between the top side and the bottom side of the strip, Cost_material is a material cost for one unit of mass, Cost_Scrap is a scrap cost per unit of mass, p is a material density, defined as a ratio between the mass and the volume of the material, Cost_blank being computed employing the following formulas:
$$M\_Section = ρ * t * W * ( {Δ}_{1} + {Δ}_{2} )$$
$$Cost\_blank = Cost\_material * M\_Section - Cost\_scrap * \% Scrap * M\_Section ,$$
wherein the strip extends over a width W in the transverse direction and Δ₁ and Δ₂ are calculated according to the method as recited in claim 10.

16. The method for the computerized calculation of a blank cost Cost_blank according to claim 15 taking into account a variable material cost per unit mass Cost_material as a function of the width of the strip wherein Cost_material is provided in the form of a database Cost_database, including a set of n elements (Width_rangeᵢ, Cost_materialᵢ), n being an integer equal to or higher than 2 and i being comprised between 1 and n, wherein Width_rangeᵢ is a width range having a minimum and maximum strip width value and Cost_materialᵢ is a material cost for one unit of mass when the width of the strip W is comprised within Width_rangeᵢ.

17. A computer program comprising instructions for a computer to carry out the method as recited in claim 10.

18. A computer-readable storage medium comprising instructions for a computer to carry out the method as recited in claim 10.

19. A blanking method comprising:
performing the method as recited in claim 10 and subsequently blanking blank A and blank B from the strip.
